(19) United States
(12) Patent Application Publication
(10) Pub. No.: US 2010/0020543 A1
(43) Pub. Date: Jan. 28, 2010

(54) LED LIGHTING DEVICE WITH LIGHT-CONDUCTING MEMBER

(76) Inventors: Chi To Yiu, Hong Kong (HK); Zepei Zhang, Shenzhen (CN); Gaojin Peng, Shenzhen (CN)

Correspondence Address: BYIP, LTD., P.O. BOX 1484, GENERAL POST OFFICE, HONG KONG, HK

(21) Appl. No.: 12/505,538

(22) Filed: Jul. 20, 2009

(30) Foreign Application Priority Data
Jul. 23, 2008 (CN) 200810145237.3

(51) Int. Cl. F21V 29/00; F21V 7/00

(52) U.S. Cl. 362/294; 362/297

(57) ABSTRACT

A light emitting diode (LED) lighting device includes an elongated light-conducting member and LED light source for emitting light. The elongated light-conducting member includes two opposite ends, a light-reflecting side and a light-emitting side. The light-reflecting side has a plurality of reflecting surfaces. The LED light source is provided at at least one of the two opposite ends of the light-conducting member. The light enters the light-conducting member through the at least one of the two opposite ends and is reflected by the reflecting surfaces from the light-reflecting side to the light-emitting side of the light-conducting member.

### CROSS-REFERENCE TO RELATED PATENT APPLICATIONS

This patent application claims priority of Chinese patent application no. 200810145237.3 filed on Jul. 23, 2008; the entire content of which is hereby incorporated by reference.

### FIELD OF PATENT APPLICATION

The present patent application relates to a light emitting diode (LED) lighting device with a light-conducting member for converting LED spot light source to soft plane light source.

### BACKGROUND

For a long time, people have been using incandescent lamps and fluorescent lamps as the main light sources. However, these light sources are high in energy consumption, and short in life span. In particular, fluorescent lamps contain mercury which causes mercury pollution and affect the environment and human's health. As light emitting diode (LED) technology continues to develop, LED lighting devices have been used as a cold light source that is high in performance-price, environmental-friendly, safe, steady in quality, long in life span, and easy to install and maintain. LED light sources can be applied in a wide range of products including green land, road, advertisement lamp boxes, city landscape, and home, etc. However, these LED light sources are formed into direct lightings. Since LEDs are bright spot light sources, they produce dazzling spot light that is not soft and even and causes discomfort to human's eyes.

The above description of the background is provided to aid in understanding a LED lighting device, but is not admitted to describe or constitute pertinent prior art to the LED lighting device with a light-conducting member disclosed in the present application, or consider any cited documents as material to the patentability of the claims of the present application.

### SUMMARY

A light emitting diode (LED) lighting device includes an elongated light-conducting member and LED light source for emitting light. The elongated light-conducting member includes two opposite ends, a light-reflecting side and a light-emitting side. The light-reflecting side has a plurality of reflecting surfaces. The LED light source is provided at at least one of the two opposite ends of the light-conducting member. The light enters the light-conducting member through the at least one of the two opposite ends and is reflected by the reflecting surfaces from the light-reflecting side to the light-emitting side of the light-conducting member.

The plurality of reflecting surfaces may be in the form of a plurality transversely extending troughs of generally V-shaped cross section, or an array of dots.

The angle of the reflecting surfaces may be between about 10° to about 170° with respect to the light-reflecting side of the light-conducting member depending on the application requirement.

The elongated light-conducting member may include a generally semi-circular cross section, a generally planar light-reflecting side on which the reflecting surfaces are formed, and a generally semi-cylindrical light-emitting side. The elongated light-conducting member may be generally D-shaped, B-shaped, shell-shaped, or polygonal in cross section.

The elongated light-conducting member may be made of an optical resin of high light conductivity. The elongated light-conducting member may be made of glass, polycarbonate, polymethyl methacrylate, or acrylic.

The LED lighting device may further include a reflective film or paint disposed on the light-reflecting side over the reflecting surfaces.

The LED lighting device may further include a printed circuit board. The LED light source is provided on the printed circuit board. The printed circuit board may include a rigid or flexible board made of an insulating or a thermal conducting material. A heat sink may be provided to connect to the printed circuit board.

The LED lighting device may further include a reflector for reflecting the light from the elongated light-conducting member to a designated light projecting area. The elongated light-conducting member is mounted within the reflector.

### BRIEF DESCRIPTION OF THE DRAWINGS

Specific embodiments of the LED lighting device with a light-conducting member disclosed in the present patent application will now be described by way of example with reference to the accompanying drawings wherein:

FIG. 1(a) is a side view of a light-conducting member of the LED lighting device according to an embodiment disclosed in the present patent application;

FIG. 1(b) is an end view of the light-conducting member of FIG. 1;

FIG. 1(c) is a perspective view of the light-conducting member of FIG. 1;

FIG. 2(a) is a side view of the LED lighting device showing the direction of light reflection;

FIG. 2(b) is an end view of the LED lighting device of FIG. 2(a) showing the direction of light reflection;

FIG. 3 illustrates the process of manufacturing of the light-conducting member of the LED lighting device according to an embodiment disclosed in the present patent application;

FIG. 4 is a perspective view of the LED lighting device with only one light-conducting member;

FIG. 5 is a front view of a LED light source of the LED lighting device;

FIG. 6 is a rear view of the LED light source of the LED lighting device of FIG. 5;

FIG. 7 is a perspective view of a LED lighting device with three light-conducting members;

FIG. 8 is a front view of the LED light source of the LED lighting device with three light-conducting members;

FIG. 9 is a rear view of the LED light source of the LED lighting device of FIG. 8;

FIG. 10 is an illustrative diagram showing the reflection of light by a reflector;

FIG. 11(a) is a side view of a light-conducting member of the LED lighting device according to another embodiment disclosed in the present patent application;

FIG. 11(b) is an end view of the light-conducting member of FIG. 11;

FIG. 11(c) is a perspective view of the light-conducting member of FIG. 11;

FIG. 12(a) is a side view of the LED lighting device with the light-conducting member of FIG. 11 showing the direction of light reflection;

FIG. 12(b) is an end view of the LED lighting device of FIG. 12(a) showing the direction of light reflection; and

FIGS. 13(a)-(d) show light-conducting members having different cross sections.

### DETAILED DESCRIPTION

Reference will now be made in detail to embodiments of the LED lighting device with a light-conducting member disclosed in the present patent application, examples of which are also provided in the following description. Exemplary embodiments of the LED lighting device with a light-conducting member disclosed in the present patent application are described in detail, although it will be apparent to those skilled in the relevant art that some features that are not particularly important to an understanding of the LED lighting device with a light-conducting member may not be shown for the sake of clarity.

Furthermore, it should be understood that the LED lighting device with a light-conducting member disclosed in the present patent application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

In addition, improvements and modifications which may become apparent to persons of ordinary skill in the art after reading this disclosure, the drawings, and the appended claims are deemed within the spirit and scope of the appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

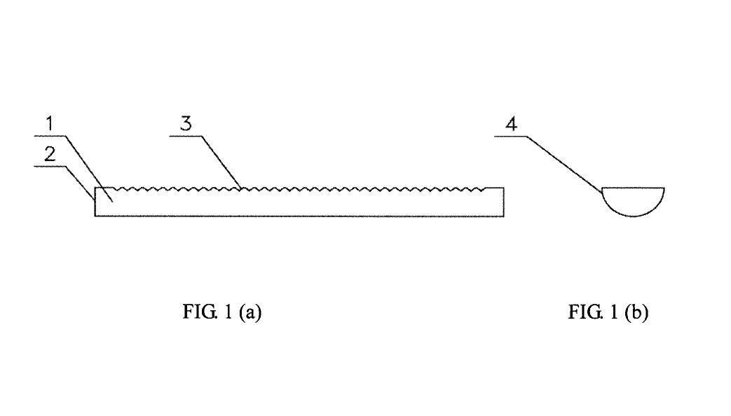

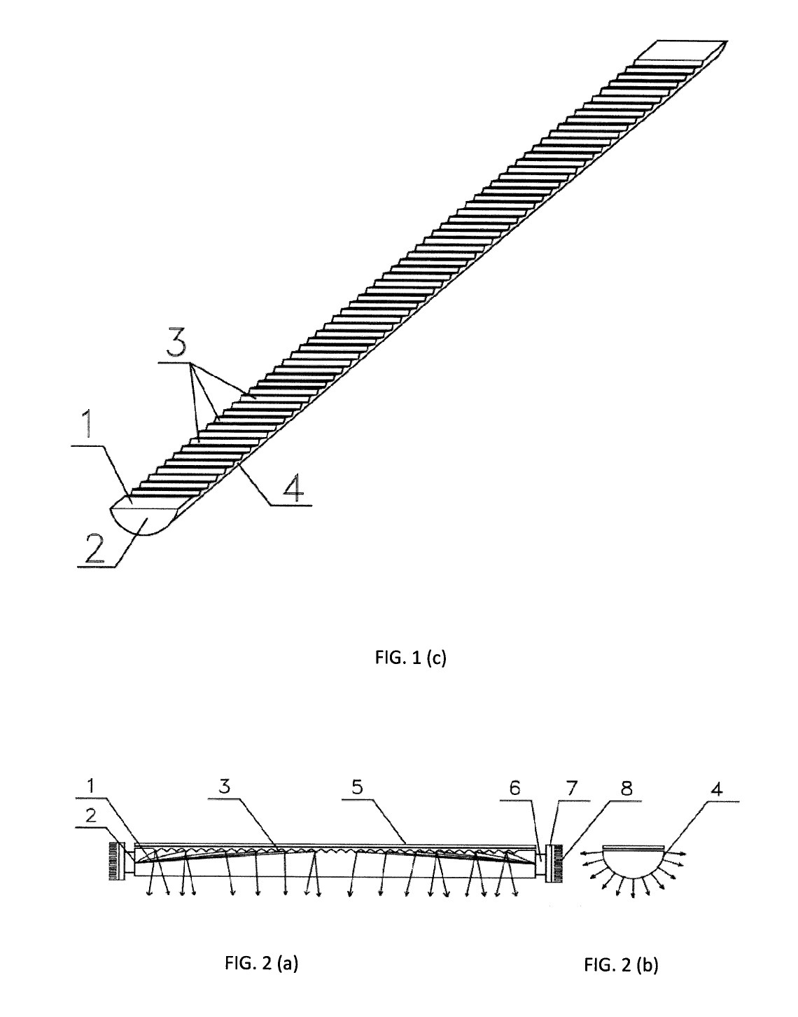

FIG. 1(a) is a side view of an elongated light-conducting member 1 of the LED lighting device according to an embodiment disclosed in the present application, and FIG. 1(b) is an end view of the light-conducting member 1 of FIG. 1(a). The light-conducting member 1 may have two opposite light-admitting ends 2, reflecting surfaces 3 formed on a generally planar light-reflecting side of the light-conducting member 1, and a light-emitting side 4. FIG. 1(c) is a perspective view of the light-conducting member 1 of FIG. 1(a).

According to the illustrated embodiment, the light-conducting member 1 has a generally semi-circular cross section. The reflecting surfaces 3 are formed along the light-reflecting side of the light-conducting member 1. The light-emitting side 4 is generally semi-cylindrical in shape.

According to the illustrated embodiment, the reflecting surfaces 3 may be in the form of a plurality of transversely extending troughs of generally V-shaped cross section. The angle of the reflecting surface 3 can be between about 10° to about 170° with respect to the generally planar light-reflecting side of the light-conducting member 1 depending on the application requirement.

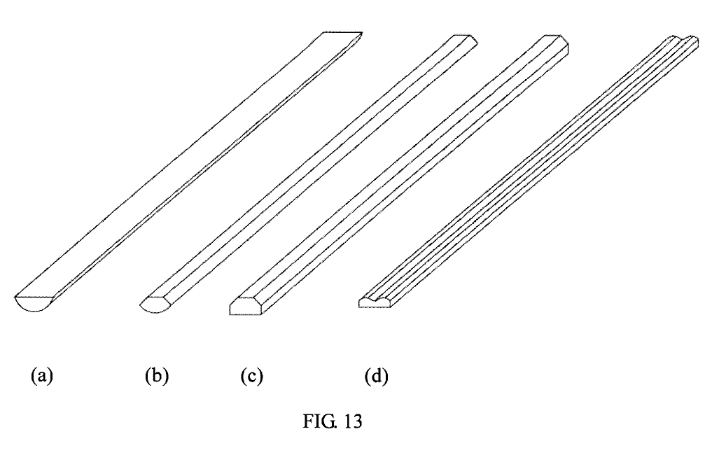

It is understood by one skilled in the art that the light-conducting member 1 can be in any other appropriate shapes. For example, the light-conducting member 1 may be generally D-shaped, shell-shaped, polygonal, and B-shaped in cross section, as depicted in FIGS. 13(a), (b), (c) and (d) respectively.

The light-conducting member 1 may be made of a material having high light-conductivity and high temperature resistance (>90° C.) features, such as optical resin in the illustrated embodiment. The light-conducting member 1 may be formed by injection molding, compression molding, machine processing, or any other appropriate methods. The light-conducting member 1 may also be made of glass, polycarbonate, polymethyl methacrylate, or acrylic.

The reflecting surfaces 3 may be formed on the light-reflecting side of the light-conducting member 1 by laser engraving, machine engraving, heat compression, or injection molding using molds such as etched molds.

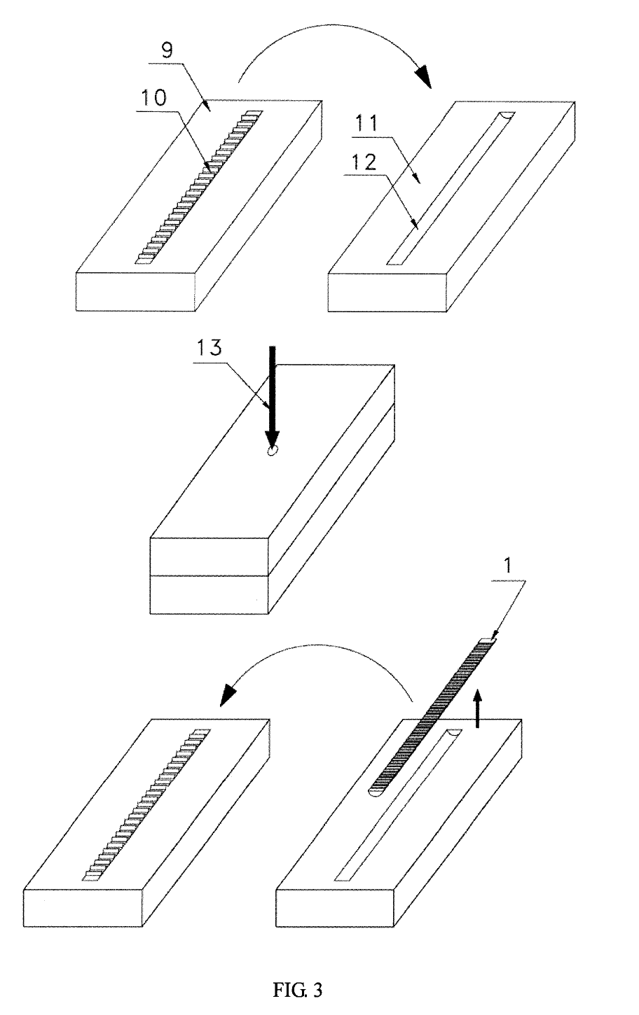

FIG. 2(a) is a side view of the LED lighting device with the light-conducting member 1 according to an embodiment disclosed in the present application, and FIG. 2(b) is an end view of the LED lighting device shown in FIG. 2(a).

A reflective film 5 may be disposed on the light-reflecting side over the reflecting surfaces 3. The reflective film 5 may be made of optical resin coated with silver or any other reflective material of high reflectivity. Alternatively, a layer of reflective paint may be disposed on the light-reflecting side over the reflecting surfaces 3.

A LED light source 6 may be provided at at least one of the two opposite ends 2 of the light-conducting member 1. For example, a plurality of LEDs 6 may be provided on each of the two opposite ends 2 of the light-conducting member 1. The LEDs 6 can be mounted on a printed circuit board 7. The printed circuit board 7 may include a rigid or flexible board made of an insulating or a thermal conducting material. A heat sink 8 may be connected to the printed circuit board 7 for dissipation of heat generated by the LEDs 6 during operation. The heat sink 8 can be in any appropriate shape and can be located in any position suitable for heat dissipation. In the illustrated embodiment, the heat sink 8 is provided on the side of the printed circuit board 7 opposite to the side on which the LEDs 6 are mounted. The heat sink 8 may be made of aluminum or any other suitable material with good heat conductivity.

The light-conducting member 1 is adapted to convert strong dazzling LED spot light source to soft and even plane or surface light source through a second order optical process. When LED light enters the light-conducting member 1 through the two opposite light-admitting ends 2, it is reflected by the reflecting surfaces 3 and the reflective film 5 from the light-reflecting side to the light-emitting side 4 of the light-conducting member 1. As shown by the arrows in FIG. 2(a), the direction of light changes from a direction generally parallel to the light-conducting member 1 to a direction towards the light-emitting side 4 of the light-conducting member 1. As shown by the arrows in FIG. 2(b), the light is reflected radially from the light-emitting side 4 of the light-conducting member 1.

It is understood by one skilled in the art that the reflecting surfaces 3 may be in other appropriate shapes so long as they can effectively reflect the LED light entering the two opposite ends 2 towards the light-emitting side 4 of the light-conducting member 1.

Although it has been described that the reflecting surfaces have generally V-shaped cross section, it is contemplated that the reflecting surfaces can have a smooth wavy cross section.

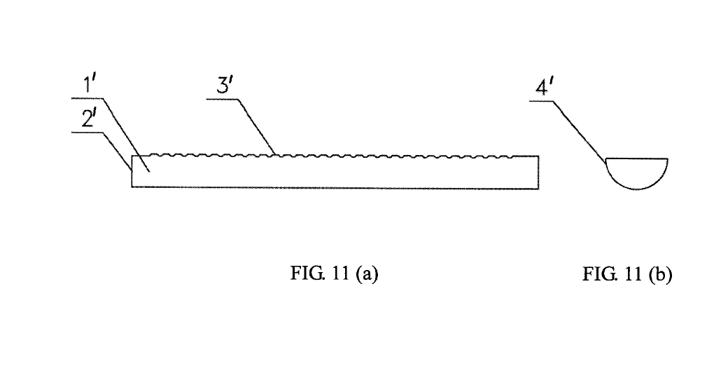

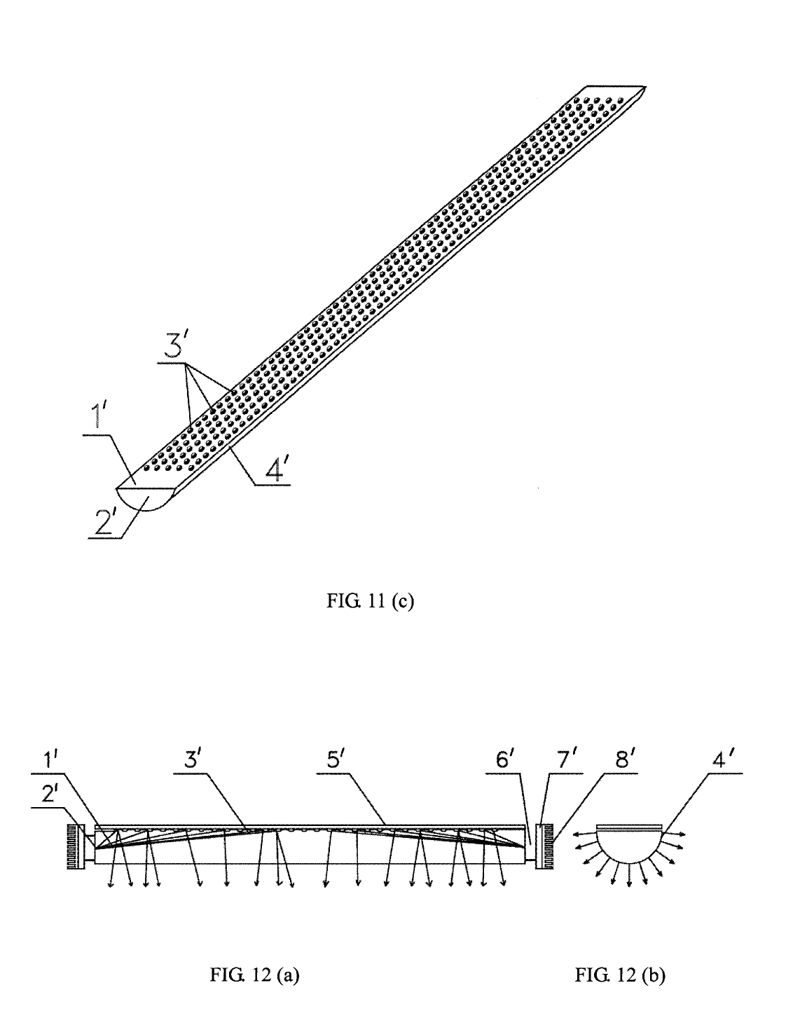

FIG. 11(a) is a side view of an elongated light-conducting member 1′ of the LED lighting device according to another embodiment disclosed in the present application, and FIG. 11(b) is an end view of the light-conducting member 1′ of FIG. 11(a). The light-conducting member 1′ may have two opposite light-admitting ends 2′, reflecting surfaces 3′ formed on a generally planar light-reflecting side of the light-conducting member 1′, and a light-emitting side 4′. FIG. 11(c) is a perspective view of the light-conducting member 1′ of FIG. 11(a).

Similar to the embodiment shown in FIG. 1(c), the light-conducting member 1′ has a generally semi-circular cross section. The reflecting surfaces 3′ are formed along the light-reflecting side of the light-conducting member 1′. The light-emitting side 4′ is generally semi-cylindrical in shape.

It is understood by one skilled in the art that the light-conducting member 1′ can be in any other appropriate shapes. For example, the light-conducting member 1′ may be generally D-shaped, shell-shaped, polygonal, and B-shaped in cross section, as depicted in FIGS. 13(a), (b), (c) and (d) respectively.

According to the illustrated embodiment, the reflecting surfaces 3′ may be in the form of an array of dots. The angle of the dots on the reflecting surface 3′ can be between about 10° to about 170° with respect to the generally planar light-reflecting side of the light-conducting member 1′ depending on the application requirement.

FIG. 12(a) is a side view of the LED lighting device with the elongated light-conducting member 1′, and FIG. 12(b) is an end view of the LED lighting device shown in FIG. 12(a).

Similar to the embodiment shown in FIG. 2(a), a reflective film or paint 5′ may be disposed on the light-reflecting side over the reflecting surfaces 3′. A LED light source 6′ may be provided at at least one of the two opposite ends 2′ of the light-conducting member 1′. The LED light source 6′ can be mounted on a printed circuit board 7′. A heat sink 8′ may be connected to the printed circuit board 7′ for dissipation of heat generated by the LED light source 6′ during operation.

FIG. 3 illustrates the process of manufacturing of the light-conducting member 1 of the LED lighting device by injection molding according to an embodiment disclosed in the present application.

FIG. 3 shows the use of an upper mold 9 and a lower mold 11 in an injection molding process for the manufacturing of the light-conducting member 1 of the present application. The upper mold 9 may have on an inner surface thereof a plurality of generally V-shaped ridges 10 for forming the generally V-shaped troughs 3 on the light-reflecting side of the light-conducting member 1. The lower mold 11 may have on an inner surface thereof a generally semi-cylindrical shaped cavity 12 for forming the light-emitting side of the light-conducting member 1. First of all, the upper mold 9 is placed on top of the lower mold 11 such that the ridges 10 are in registration with the cavity 12 and the molds 9, 11 are closed. Then, a molding material can be injected into the molds 9, 11 through the opening provided on the upper mold 9, as illustrated by arrow 13. Finally, the upper mold 9 can be opened and the formed light-conducting member 1 can be removed from the lower mold 11. This completes the manufacturing process of the light-conducting member 1 by injection molding.

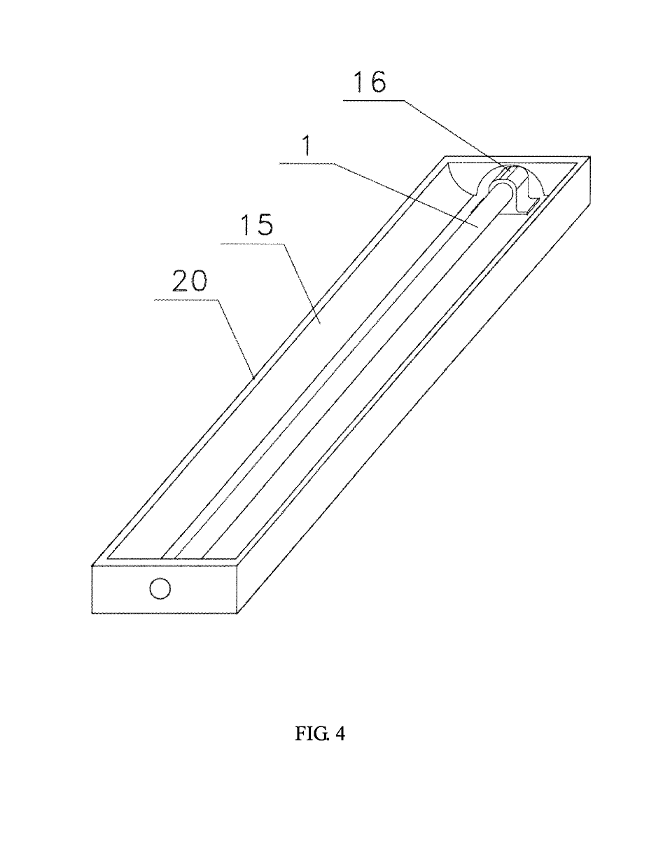

FIG. 4 is a perspective view of a LED lighting device having only one light-conducting member 1 mounted thereon. The light-conducting member 1 can be mounted within a housing 20 by two brackets 16 provided at the two opposite ends of the housing 20 respectively. A reflector 15 may be employed to reflect the light emitting from the light-emitting side 4 of the light-conducting member 1. The reflector 15 may be in the form of a reflective mirror, or has a matte surface for diffuse reflection. The reflector 15 can be a directional reflector having the function of directional reflection such that light can be projected onto a designated light projecting surface to satisfy different lighting requirements under different circumstances.

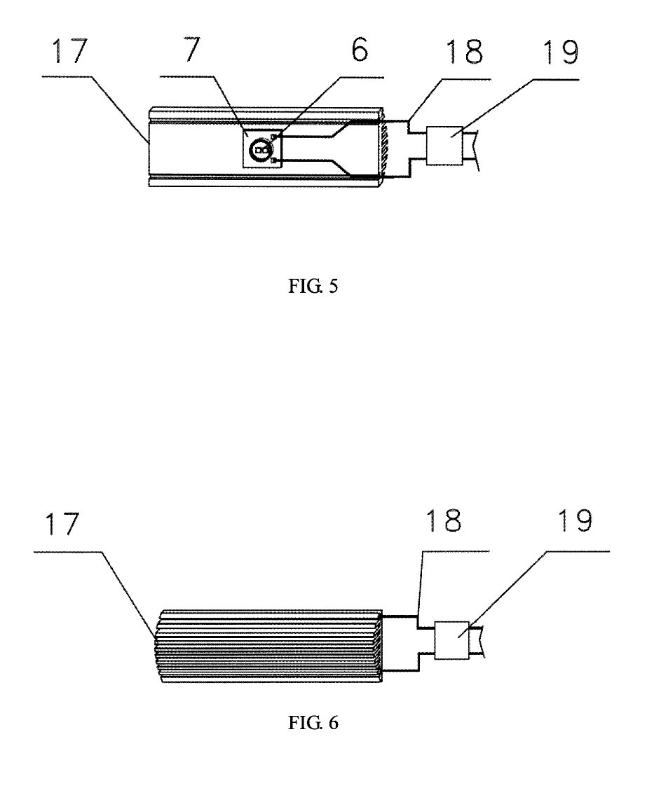

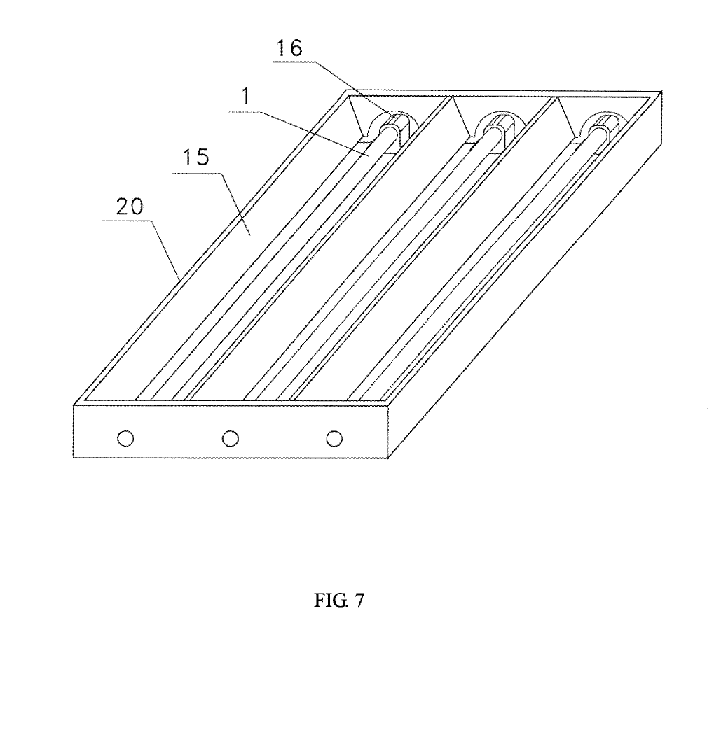

FIGS. 5 and 6 are front and rear views of the LED light source of the LED lighting device respectively.

The LED light source 6 may include one or more low-power LED lamps (below 0.1 W per lamp), or medium power LED lamps (0.1-0.5 W per lamp), or high-power LED lamps (over 0.5 W per lamp). The LED lamps of the LED light source 6 can be packed in surface-mount-device (SMD) type or lead frame-type LED packages. The LED lamps can produce different colours. Depending on the visual effect to be achieved, the LED light source 6 may contain a plurality of LED lamps of the same colour, or a plurality of LED lamps of different colours. The colours emitting from the LED lamps can be any visible lights with a peak wavelength λp ranging from about 430 nm to about 700 nm, and blending white light. The luminous efficacy of the LED lamps can be more than 15 Lm/w. The LED lamps 4 can be suitable for operation in a wide range of temperatures ranging from −40° C. to 70° C. The life span of the LED lamps can be up to ten years (up to about 100,000 hours), which is tens times more than that of the existing incandescent lamps (about 2,000-8,000 hours).

LED lamps consume 10-50% less energy than incandescent lamps and fluorescent lamps. Further, the switch-on time of LED lamps is hundred times faster than that of incandescent lamps and fluorescent lamps. Hence, LED lamps have a greater advantage and prospect in areas such as traffic management, interior illumination in vehicles and homes, etc. Furthermore, LED lamp is a cold light source that can generate less heat, produce no electromagnetic radiation, and avoid mercury pollution as in fluorescent lamps.

An AC-DC converter 19 can be provided to convert AC power input into DC power output of constant current or voltage, and supply electric power to the LEDs of the LED light source 6 through electrical wires 18. A heat sink 17 is connected to the printed circuit board 7. In the illustrated embodiment, the heat sink 17 is located at and extending across each of the two opposite ends of the lousing 20.

FIG. 7 is a perspective view of a LED lighting device with three light-conducting members 1 disposed substantially parallel to one another. Although it is shown and described that there are three light-conducting members disposed parallel to one another, it is understood that the number of light-conducting member 1 and their arrangement may vary depending on design and requirements.

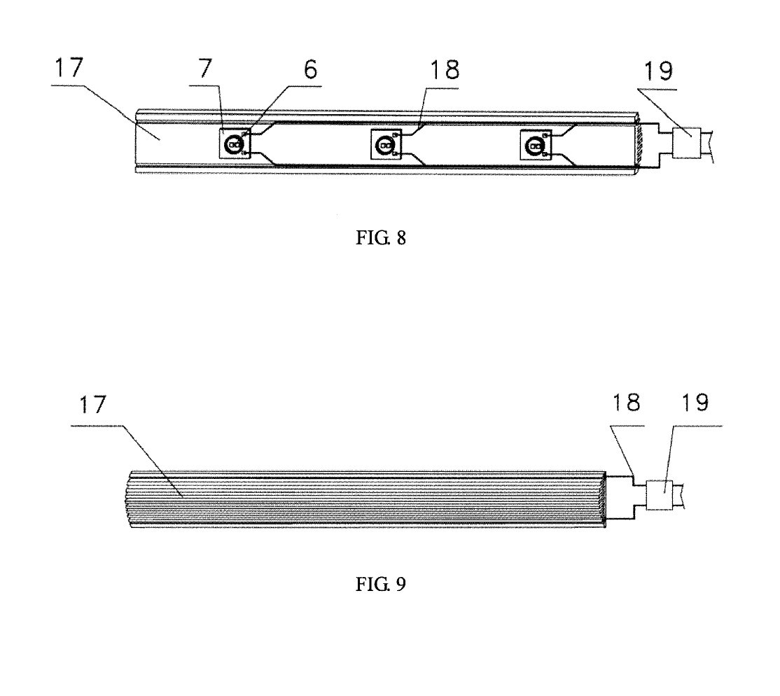

FIGS. 8 and 9 are front and rear views of the LED light source of the LED lighting device with three light-conducting members. It can be seen that on each side of the housing 20, there are three LED light sources 6 mounted on three printed circuit boards 7 respectively. The LED light sources 6 and printed circuit boards 7 are connected to an AC-DC converter 19 through electrical wires 18. Heat sink 17 is about three times longer than the heat sink in the previous embodiment shown in FIGS. 5 and 6.

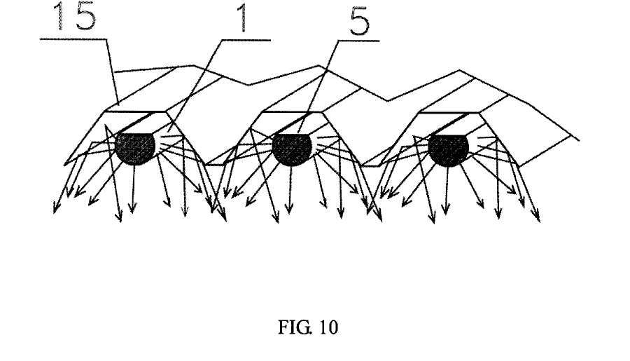

FIG. 10 is an illustrative diagram showing the reflection of light by a reflector 15. The reflector 15 may be employed to reflect the light emitting radially from the light-emitting side 4 of the light-conducting members 1, as shown by the arrows. The reflector 15 can be a directional reflector for directing light towards one side of the LED lighting device such that light can be projected onto a designated light projecting surface.

The manufacturing process of the LED lighting device may include the steps of (i) designing the light-conducting member, (ii) forming the molds for injection molding, (iii) carrying out the injection molding process, (iv) assembling the light-conducting member, the reflector and the housing, (v) assembling the LED light sources, and (vi) testing the finished product.

While the LED lighting device with a light-conducting member disclosed in the present application has been shown and described with particular references to a number of preferred embodiments thereof, it should be noted that various other changes or modifications may be made without departing from the scope of the appending claims.

What is claimed is:

1. A light emitting diode (LED) lighting device comprising:
an elongated light-conducting member comprising two opposite ends, a light-reflecting side and a light-emitting side, the light-reflecting side comprising a plurality of reflecting surfaces; and
a LED light source for emitting light, the LED light source provided at at least one of the two opposite ends of the light-conducting member, the light entering the light-conducting member through the at least one of the two opposite ends and being reflected by the reflecting surfaces from the light-reflecting side to the light-emitting side of the light-conducting member.

2. The LED lighting device as claimed in claim 1, wherein the plurality of reflecting surfaces comprises a plurality transversely extending troughs of generally V-shaped cross section.

3. The LED lighting device as claimed in claim 1, wherein the angle of the reflecting surfaces is between about 10° to about 170° with respect to the light-reflecting side of the light-conducting member.

4. The LED lighting device as claimed in claim 1, wherein the elongated light-conducting member comprises a generally semi-circular cross section, a generally planar light-reflecting side on which the reflecting surfaces are formed, and a generally semi-cylindrical light-emitting side.

5. The LED lighting device as claimed in claim 1, wherein the elongated light-conducting member is made of a material with high light conductivity.

6. The LED lighting device as claimed in claim 1, wherein the elongated light-conducting member is made of optical resin, polycarbonate, polymethyl methacrylate, glass, or acrylic.

7. The LED lighting device as claimed in claim 1, further comprising a reflective film disposed on the light-reflecting side over the reflecting surfaces.

8. The LED lighting device as claimed in claim 7, wherein the reflective film is made of an optical resin coated with silver.

9. The LED lighting device as claimed in claim 1, further comprising a printed circuit board, wherein the LED light source is provided on the printed circuit board.

10. The LED lighting device as claimed in claim 9, wherein the printed circuit board comprises a rigid or flexible board made of an insulating or a thermal conducting material.

11. The LED lighting device as claimed in claim 9, further comprising a heat sink connected to the printed circuit board.

12. The LED lighting device as claimed in claim 1, further comprising a reflector for reflecting the light from the elongated light-conducting member to a designated light projecting area, wherein the elongated light-conducting member is mounted within the reflector.

13. The LED lighting device as claimed in claim 1, wherein the plurality of reflecting surfaces comprises an array of dots.

14. The LED lighting device as claimed in claim 1, wherein the elongated light-conducting member is generally D-shaped, shell-shaped, polygonal, or B-shaped in cross section.

15. The LED lighting device as claimed in claim 1, further comprising a layer of reflective paint disposed on the light-reflecting side over the reflecting surfaces.

16. A light emitting diode (LED) lighting device comprising:
an elongated light-conducting member made of a material with high light conductivity, the elongated light-conducting member comprising two opposite ends, a light-reflecting side and a light-emitting side, the light-reflecting side comprising a plurality of reflecting surfaces in the form of a plurality transversely extending troughs of generally V-shaped cross section; and
a LED light source for emitting light, the LED light source provided at at least one of the two opposite ends of the light-conducting member, the light entering the light-conducting member through the at least one of the two opposite ends and being reflected by the reflecting surfaces and the reflective film from the light-reflecting side to the light-emitting side of the light-conducting member.

17. The LED lighting device as claimed in claim 16, further comprising a reflective film disposed on the light-reflecting side over the reflecting surfaces.

18. The LED lighting device as claimed in claim 16, wherein the elongated light-conducting member comprises a generally semi-circular cross section, a generally planar light-reflecting side on which the reflecting surfaces are formed, and a generally semi-cylindrical light-emitting side.

19. A light emitting diode (LED) lighting device comprising:
an elongated light-conducting member made of a material with high light conductivity, the elongated light-conducting member comprising two opposite ends, a light-reflecting side and a light-emitting side, the light-reflecting side comprising a plurality of reflecting surfaces which comprise an array of dots; and
a LED light source for emitting light, the LED light source provided at at least one of the two opposite ends of the light-conducting member, the light entering the light-conducting member through the at least one of the two opposite ends and being reflected by the reflecting surfaces and the reflective film from the light-reflecting side to the light-emitting side of the light-conducting member.

20. The LED lighting device as claimed in claim 19, wherein the elongated light-conducting member comprises a generally semi-circular cross section, a generally planar light-reflecting side on which the reflecting surfaces are formed, and a generally semi-cylindrical light-emitting side.
